(19) United States
(12) Patent Application Publication
(10) Pub. No.: US 2011/0127905 A1
(43) Pub. Date: Jun. 2, 2011

(54) ALKALINE EARTH BORATE PHOSPHORS

(75) Inventors: Anant Achyut Setlur, Niskayuna, NY (US); Satya Kishore Manepalli, Bangalore (IN)

(73) Assignee: GENERAL ELECTRIC COMPANY, Schenectady, NY (US)

(21) Appl. No.: 12/629,595

(22) Filed: Dec. 2, 2009

(51) Int. Cl. H01J 1/62; C09K 11/78; C09K 11/55

(52) U.S. Cl. 313/503; 252/301.4 R

(57) ABSTRACT

A phosphor of formula I is included phosphor composition in a lighting apparatus capable of emitting white light

Ba₂₋ₐSrₐCa_{1-x-y-z}MgₓCe_{y}M¹_{b}M²_{z}(BO₃)₂ (I)
wherein
M¹ is Eu, Tb, Pr, Dy, Mn, or a combination thereof;
M² is Li, Na, K, Rb, or a combination thereof;
a≧0;
b≦0.1;
0.95>x>0;
0<y≦0.1; and
z≦0.1.
   The lighting apparatus includes a semiconductor light source in addition to the phosphor composition.

### STATEMENT REGARDING FEDERALLY SPONSORED RESEARCH AND DEVELOPMENT

This invention was made with Government support under contract number DE-FC26-06NT42934 awarded by the U.S. Department of Energy. The Government has certain rights in the invention.

### BACKGROUND

Over the past ten years, developments and breakthroughs in solid state lighting based on phosphor downconversion of InGaN LEDs have shown the potential for replacing traditional fluorescent and incandescent lamps. These colored semiconductor light emitting devices, including light emitting diodes and lasers (both are generally referred to herein as LEDs), have been also produced from Group III-V alloys such as gallium nitride (GaN). To form the LEDs, layers of the alloys are typically deposited epitaxially on a substrate, such as silicon carbide or sapphire, and may be doped with a variety of n and p type dopants to improve properties, such as light emission efficiency. With reference to the InGaN-based LEDs, light is generally emitted in the UV and/or blue range of the electromagnetic spectrum. Until quite recently, LEDs have not been suitable for lighting uses where a bright white light is needed, due to the inherent color of the light produced by the LED.

Recently, techniques have been developed for converting the light emitted from LEDs to useful light for illumination purposes. In one technique, the LED is coated or covered with a phosphor layer. A phosphor is a luminescent material that absorbs radiation energy in a portion of the electromagnetic spectrum and emits energy in another portion of the electromagnetic spectrum. Phosphors of one important class are crystalline inorganic compounds of very high chemical purity and of controlled composition to which small quantities of other elements (called “activators”) have been added to convert them into efficient fluorescent materials. With the right combination of activators and host inorganic compounds, the color of the emission can be controlled. Most useful and well-known phosphors emit radiation in the visible portion of the electromagnetic spectrum in response to excitation by electromagnetic radiation outside the visible range.

By interposing a phosphor excited by the radiation generated by the LED, light of a different wavelength, e.g., in the visible range of the spectrum, may be generated. Colored LEDs are often used in toys, indicator lights and other devices. Manufacturers are continuously looking for new colored phosphors for use in such LEDs to produce custom colors and higher luminosity.

In addition to colored LEDs, a combination of LED generated light and phosphor generated light may be used to produce white light. The most popular white LEDs are based on blue emitting InGaN chips. The blue emitting chips are coated with a phosphor that converts some of the blue radiation to a complementary color, e.g. a yellow-green emission. The total of the light from the phosphor and the LED chip provides a color point with corresponding color coordinates (x and y) and correlated color temperature (CCT), and its spectral distribution provides a color rendering capability, measured by the color rendering index (CRI).

One known white light emitting device comprises a blue light-emitting LED having a peak emission wavelength in the blue range (from about 440 nm to about 480 nm) combined with a phosphor, such as cerium doped yttrium aluminum garnet Y₃Al₅O₁₂:Ce³⁺ (“YAG”). The phosphor absorbs a portion of the radiation emitted from the LED and converts the absorbed radiation to a yellow-green light. The remainder of the blue light emitted by the LED is transmitted through the phosphor and is mixed with the yellow light emitted by the phosphor. A viewer perceives the mixture of blue and yellow light as a white light.

Such systems can be used to make white light sources having correlated color temperatures (CCTs) of >4500 K and color rendering indicies (CRIs) of about 70-75. While this range is suitable for many applications, general illumination sources usually require higher CRIs and lower CCTs. Given the high quantum efficiency of YAG:Ce at room and elevated temperatures and the strong blue absorption from the allowed 4f¹→5d¹ Ce³⁺, such a system fulfills many of the requirements for LED lighting. The only significant problem is that they typically cannot fulfill the color requirements for general illumination, low CCTs (<3500) and higher CRIs. In order to fulfill these requirements, new phosphor compositions are needed.

Cerium-doped borate phosphors with Na charge compensation, Ba₂Mg(BO₃)₂:Ce, Na and Ba₂Ca(BO₃)₂:Ce, Na have been reported ((Lin, et al., J. Mater. Res. v. 21, pp. 864-9 (2006), and Lin, et al., Phys. Rev. B v. 76, article no. 035117 (2007)). For Ba₂Mg(BO₃)₂:Ce, Na, there is no strong excitation at wavelengths longer than 350 nm, and for Ba₂Ca(BO₃)₂:Ce, Na, there is excitation in the near-UV/violet spectra region, but the emission maximum is at ˜490 nm, which is less desirable as a green phosphor.

### BRIEF DESCRIPTION

Briefly, in one aspect, the present invention relates to phosphors of formula I

Ba₂₋ₐSrₐCa_{1-x-y-z}MgₓCe_{y}M¹_{b}M²_{z}(BO₃)₂ (I)
wherein
M¹ is Eu, Tb, Pr, Dy, Mn, or a combination thereof;
M² is Li, Na, K, Rb, or a combination thereof;
a≧0;
b≦0.1;
0.95>x>0;
0<y≦0.1; and
z≦0.1.

Combination of Ca and Mg in the phosphors of formula I results materials having longer wavelength excitation and emission bands, both of which are desirable for use in LED-lighting applications. Quantum efficiency of the phosphors is about 80-85% of standard LED phosphors for an unoptimized synthesis process. Phosphors of formula I may be blended with other blue, yellow, orange, and red phosphors to yield white light phosphor blends with correlated color temperature (CCTs) ranging from 2500-10000K and CRIs ranging from 50-99.

Accordingly, in another aspect, the present invention relates to a phosphor blend including a phosphor of formula I.

In yet another aspect, the present invention relates to a lighting apparatus capable of emitting white light. The lighting apparatus includes a semiconductor light source; and a phosphor composition radiationally coupled to the light source, and containing a phosphor of formula I.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic cross-sectional view of a lighting apparatus according to the present invention.

FIG. 2 is an emission spectrum of prior art phosphor Ba₂(Ca_{0.98}Ce_{0.01}Na_{0.01})(BO₃)₂ after excitation at a wavelength of 405 nm.

FIG. 3 is an emission spectrum of a phosphor according to the present invention, of formula Ba₂(Ca_{0.78}Mg_{0.2}Ce_{0.01}Na_{0.01})(BO₃)₂, after excitation at a wavelength of 405 nm.

### DETAILED DESCRIPTION

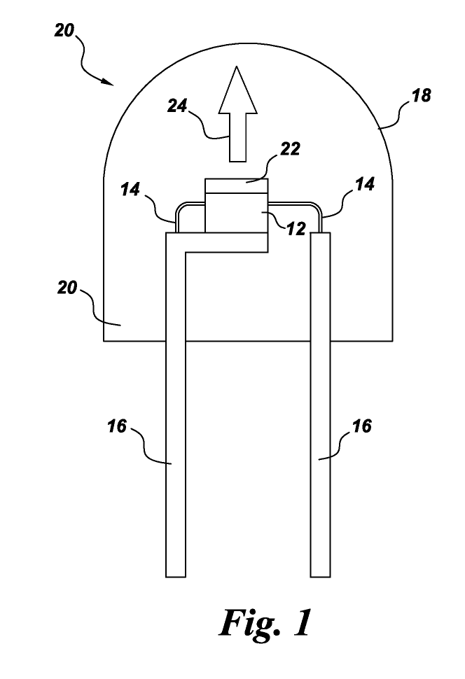

With reference to FIG. 1, a lighting apparatus or light emitting assembly or lamp 10 is shown in accordance with one embodiment of the present invention. Lighting apparatus 10 comprises a semiconductor UV radiation source, such as a light emitting diode (LED) chip 12 and leads 14 electrically attached to the LED chip. The leads 14 may comprise thin wires supported by a thicker lead frame(s) 16 or the leads may comprise self supported electrodes and the lead frame may be omitted. The leads 14 provide current to the LED chip 12 and thus cause the LED chip 12 to emit radiation.

The lamp may include any semiconductor blue or UV light source that is capable of producing white light when its emitted radiation is directed onto the phosphor. In one embodiment, the semiconductor light source comprises a blue emitting LED doped with various impurities. Thus, the LED may comprise a semiconductor diode based on any suitable III-V, II-VI or IV-IV semiconductor layers and having an emission wavelength of about 250 to 550 nm. In particular, the LED may contain at least one semiconductor layer comprising GaN, ZnSe or SiC. For example, the LED may comprise a nitride compound semiconductor represented by the formula InᵢGaⱼAlₖN (where 0≦i; 0≦j; 0≦k and i+j+k=1) having an emission wavelength greater than about 250 nm and less than about 550 nm. Preferably, the chip is a near-uv or blue emitting LED having a peak emission wavelength from about 400 to about 500 nm. Such LED semiconductors are known in the art. The radiation source is described herein as an LED for convenience. However, as used herein, the term is meant to encompass all semiconductor radiation sources including, e.g., semiconductor laser diodes.

Although the general discussion of the exemplary structures of the invention discussed herein are directed toward inorganic LED based light sources, it should be understood that the LED chip may be replaced by another radiation source unless otherwise noted and that any reference to LED chip or semiconductor is merely representative of any appropriate radiation source.

The LED chip 12 may be encapsulated within a shell 18, which encloses the LED chip and an encapsulant material 20. The shell 18 may be, for example, glass or plastic. Preferably, the LED 12 is substantially centered in the encapsulant 20. The encapsulant 20 is preferably an epoxy, plastic, low temperature glass, polymer, thermoplastic, thermoset material, resin or other type of LED encapsulating material as is known in the art. Optionally, the encapsulant 20 is a spin-on glass or some other high index of refraction material. Preferably, the encapsulant material 20 is an epoxy or a polymer material, such as silicone. Both the shell 18 and the encapsulant 20 are preferably transparent or substantially optically transmissive with respect to the wavelength of light produced by the LED chip 12 and a phosphor composition 22 (described below). Alternately, the lamp may 10 may only comprise an encapsulant material without an outer shell 18. The LED chip 12 may be supported, for example, by the lead frame 16, by the self supporting electrodes, the bottom of the shell 18, or by a pedestal (not shown) mounted to the shell or to the lead frame. In some embodiments, the LED chip 12 is mounted in a reflective cup (not shown). The cup may be made from or coated with a reflective material, such as alumina, titania, or other dielectric powder known in the art. A preferred reflective material is Al₂O₃.

Lighting apparatus 10 includes phosphor composition 22, described below, radiationally coupled to the LED chip 12. Radiationally coupled means that the elements are associated with each other so radiation from one is transmitted to the other. Phosphor composition 22 is deposited on the LED 12 by any appropriate method. For example, a water based suspension of the phosphor(s) can be formed, and applied as a phosphor layer to the LED surface. In one such method, a silicone slurry in which the phosphor particles are randomly suspended is placed around the LED. This method is merely exemplary of possible positions of the phosphor composition 22 and LED 12. Thus, the phosphor composition 22 may be coated over or directly on the light emitting surface of the LED chip 12 by coating and drying the phosphor suspension over the LED chip 12. Both the shell 18 and the encapsulant 20 should be transparent to allow white light 24 to be transmitted through those elements. Although not intended to be limiting, in one embodiment, the median particle size of the phosphor composition may be from about 1 to about 10 microns.

In other embodiments, the phosphor composition 22 is interspersed within the encapsulant material 20, instead of being formed directly on the LED chip 12. The phosphor (in the form of a powder) may be interspersed within a single region of the encapsulant material 20 or, more preferably, throughout the entire volume of the encapsulant material. Blue light emitted by the LED chip 12 mixes with the light emitted by the phosphor composition 22, and the mixed light appears as white light. If the phosphor is to be interspersed within the material of encapsulant 20, then a phosphor powder may be added to a polymer precursor, loaded around the LED chip 12, and then the polymer precursor may be cured to solidify the polymer material. Other known phosphor interspersion methods may also be used, such as transfer loading.

In yet another embodiment, phosphor composition 22 is coated onto a surface of the shell 18, instead of being formed over the LED chip 12. The phosphor composition is preferably coated on the inside surface of the shell 18, although the phosphor may be coated on the outside surface of the shell, if desired. The phosphor composition 22 may be coated on the entire surface of the shell or only a top portion of the surface of the shell. The UV light emitted by the LED chip 12 mixes with the light emitted by the phosphor composition 22, and the mixed light appears as white light. Of course, the phosphor may be located in any two or all three locations or in any other suitable location, such as separately from the shell or integrated into the LED.

Phosphor composition 22 includes a phosphor of formula I, optionally blended with one or more other phosphors. In particular embodiments, the phosphor of formula I is Ba₂₋ₐSrₐCa_{1-x-y-z}MgₓCe_{y}M²_{z}(BO₃)₂. In other embodiments the phosphor is of formula Ba₂Ce_{1-x-y-z}MgₓCe_{y}M¹_{b}M²_{z}(BO₃)₂. In yet other embodiments, phosphor is of formula Ba₂Ce_{1-x-y-z}MgₓCe_{y}M²_{z}(BO₃)₂. In each of these embodiments, x is greater than or equal to 0.5, and in particular, ranges between about 0.1 and about 0.5. One particularly useful phosphor is of formula Ba₂Ca_{0.78}Mg_{0.2}Ce_{0.01}Na_{0.01}(BO₃)₂.

When used with an LED emitting at from 350 to 550 nm and one or more other appropriate phosphors, the resulting lighting system will produce a light having a white color, the characteristics of which will be discussed in more detail below. Lamp 10 may also include scattering particles (not shown), which are embedded in the encapsulant material. The scattering particles may comprise, for example, Al₂O₃ particles such as alumina powder or TiO₂ particles. The scattering particles effectively scatter the coherent light emitted from the LED chip, preferably with a negligible amount of absorption.

The phosphors of formula I may contain optically inert trace impurities. The presence of such impurities in an amount up to 10% by weight of the phosphor composition will not significantly affect the quantum efficiency or color of the phosphor.

It may be desirable to add pigments or filters to the phosphor material. The phosphor layer 22 may also comprises from 0 up to about 5% by weight (based on the total weight of the phosphors) of a pigment or other UV absorbent material capable of absorbing UV radiation having a wavelength between 250 nm and 450 nm.

Suitable pigments or filters include any of those known in the art that are capable of absorbing radiation generated between 250 nm and 450 nm. Such pigments include, for example, nickel titanate or praseodimium zirconate. The pigment is used in an amount effective to filter 10% to 100% of the radiation generated in the 250 nm to 450 nm range.

Phosphors of formula I may be produced using known solid state reaction methods by combining, for example, elemental oxides, carbonates and/or hydroxides as starting materials. Other starting materials may include nitrates, sulfates, acetates, citrates, or oxalates. Alternately, coprecipitates of the rare earth oxides could be used as the starting materials for the rare earth elements. Thus, according to one method for producing the phosphors of formula I, carbonates may be used as a source for alkali and alkaline earth metals, and H₃BO₃ may be used as a source of B. In a typical process, the starting materials are combined via a dry or wet blending process and fired in air or under a slightly reducing atmosphere at from, e.g., 1000 to 1600° C.

In one exemplary process of making the above phosphors, an array slurry method is used. Raw materials (such as CaCO₃, SrCO₃, CeO₂, MgO, Na₂CO₃ and H₃BO₃) are milled down to micron size powders and then dispersed in water up to 16% by weight solid loading. The slurries may be dispensed into alumina crucibles via a commercial liquid handler under vigorous mixing. The homogenous solid mixture results after water evaporation after firing the slurries at 800-1600° C. under a reducing atmosphere (e.g. 1% H₂ in air).

In another typical process, the starting materials are combined via a dry or wet blending process and fired in air or under a reducing atmosphere at from, e.g., 800 to 1600° C. A fluxing agent may be added to the mixture before or during the step of mixing. This fluxing agent may be AlF₃, NH₄Cl or any other conventional fluxing agent, such as a fluoride of an alkali/alkaline earth metal. A quantity of a fluxing agent of less than about 20, preferably less than about 10, percent by weight of the total weight of the mixture is adequate for fluxing purposes.

The starting materials may be mixed together by any mechanical method including, but not limited to, stirring or blending in a high-speed blender or a ribbon blender. The starting materials may be combined and pulverized together in a bowl mill, a hammer mill, or a jet mill. The mixing may be carried out by wet milling especially when the mixture of the starting materials is to be made into a solution for subsequent precipitation. If the mixture is wet, it may be dried first before being fired under a reducing atmosphere at a temperature from about 900° C. to about 1700° C., preferably from about 1000° C. to about 1600° C., for a time sufficient to convert all of the mixture to the final composition.

The firing may be conducted in a batchwise or continuous process, preferably with a stirring or mixing action to promote good gas-solid contact. The firing time depends on the quantity of the mixture to be fired, the rate of gas conducted through the firing equipment, and the quality of the gas-solid contact in the firing equipment. Typically, a firing time up to about 10 hours is adequate. The reducing atmosphere typically comprises a reducing gas such as hydrogen, carbon monoxide, or a combination thereof, optionally diluted with an inert gas, such as nitrogen or helium, or a combination thereof. Alternatively, the crucible containing the mixture may be packed in a second closed crucible containing high-purity carbon particles and fired in air so that the carbon particles react with the oxygen present in air, thereby, generating carbon monoxide for providing a reducing atmosphere.

These compounds may be blended and dissolved in a nitric acid solution. The strength of the acid solution is chosen to rapidly dissolve the oxygen-containing compounds and the choice is within the skill of a person skilled in the art. Ammonium hydroxide is then added in increments to the acidic solution. An organic base such as methanolamine, ethanolamine, propanolamine, dimethanolamine, diethanolamine, dipropanolamine, trimethanolamine, triethanolamine, or tripropanolamine may be used in place of ammonium hydroxide.

The precipitate is filtered, washed with deionized water, and dried. The dried precipitate is ball milled or otherwise thoroughly blended and then calcined in air at about 400° C. to about 1600° C. for a sufficient time to ensure a substantially complete dehydration of the starting material. The calcination may be carried out at a constant temperature. Alternatively, the calcination temperature may be ramped from ambient to and held at the final temperature for the duration of the calcination. The calcined material is similarly fired at 1000-1600° C. for a sufficient time under a reducing atmosphere such as H₂, CO, or a mixture of one of these gases with an inert gas, or an atmosphere generated by a reaction between a coconut charcoal and the products of the decomposition of the starting materials to covert all of the calcined material to the desired phosphor composition.

The phosphors of formula I may be blended with one or more additional phosphors for use in LED light sources. Thus, in another embodiment, an LED lighting apparatus is provided including a phosphor composition 22 comprising a blend of a phosphor of formula I with one or more additional phosphors. When used in a lighting apparatus in combination with a blue or near UV LED emitting radiation in the range of about 250 to 550 nm, the resultant light emitted by the assembly will be a white light. Other phosphors such as green, blue, orange, or other color phosphors may be used in the blend to customize the white color of the resulting light and produce higher CRI sources. When used in conjunction with a LED chip emitting at from, e.g., 250 to 550 nm, the lighting apparatus preferably includes a blue phosphor for converting some, and preferably all, of the LED radiation to blue light, which in turn can then be efficiently converted by the present inventive phosphors. While not intended to be limiting, suitable phosphors for use in the blend with the present invention phosphors include those listed in U.S. Pat. No. 7,274,045 and U.S. Pat. No. 7,094,362, both assigned to the General Electric Company.

The ratio of each of the individual phosphors in the phosphor blend may vary depending on the characteristics of the desired light output. The relative proportions of the individual phosphors in the various embodiment phosphor blends may be adjusted such that when their emissions are blended and employed in an LED lighting device, there is produced visible light of predetermined x and y values on the CIE chromaticity diagram. As stated, a white light is preferably produced. This white light may, for instance, may possess an x value in the range of about 0.30 to about 0.55, and a y value in the range of about 0.30 to about 0.55. As stated, however, the exact identity and amounts of each phosphor in the phosphor composition can be varied according to the needs of the end user.

When combined with a LED emitting at from 350-550 nm and, optionally, one or more additional phosphors, the use of a phosphor of formula I allows for a white LED device having a higher CRI value and lower CCT as compared to a TAG based lighting device. LED devices having CCT values from about 2500 to about 10000, preferably from 2500 to 4500, and high CRI values from about 70 to 95 can be made. This allows for an increased ccx coordinate and a reduced ccy coordinate on the CIE color chromaticity diagram for the LED device, resulting in a “warmer” color LED.

The phosphor composition described above may be used in additional applications besides LEDs. For example, the material may be used as a phosphor in a fluorescent lamp, in a cathode ray tube, in a plasma display device or in a liquid crystal display (LCD). The material may also be used as a scintillator in an electromagnetic calorimeter, in a gamma ray camera, in a computed tomography scanner or in a laser. These uses are meant to be merely exemplary and not exhaustive.

### EXAMPLES

General Synthesis Procedure:

1. Components dry-blended with ZrO2 media in a Nalgene bottle for 1 hour.
2. Fired at 700° C./8 hours/0.25% H₂ in an uncovered alumina crucible and re-blended.
3. Re-fired at 850° C./8 hours/0.25% H₂ in an uncovered alumina crucible.

### Example 1 Comparative Example

### Synthesis of Ba₂(Ca_{0.98}Ce_{0.01})(BO₃)₂

Materials
BaCO₃: 4.539 g
CaCO₃: 1.140 g
H₃BO₃: 1.564 g (Excess added for fluxing)
CeO₂: 0.020 g

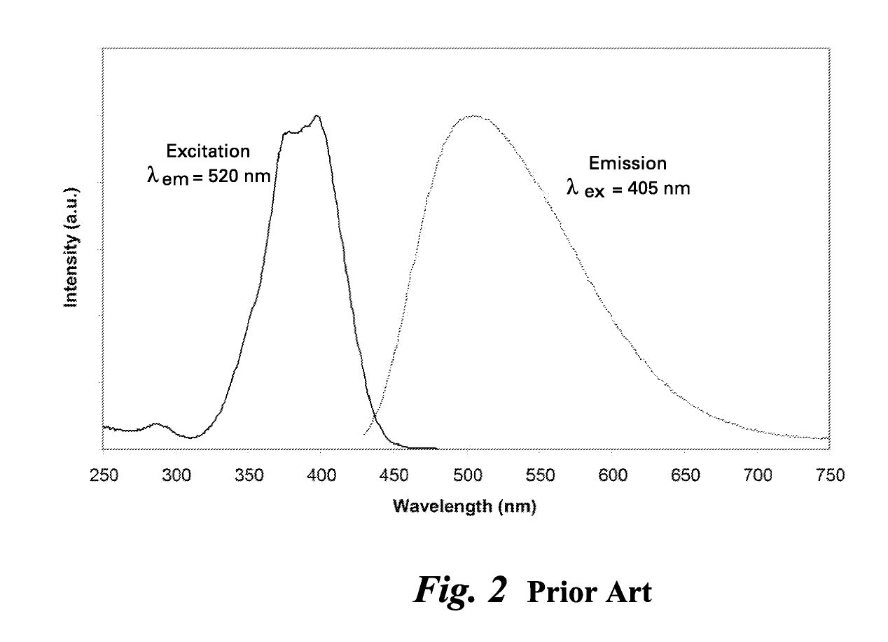

An emission spectrum of Ba₂(Ca_{0.98}Ce_{0.01}Na_{0.01})(BO₃)₂ recorded with excitation at a wavelength of 405 nm is shown in FIG. 2.

### Example 2

### Synthesis of Ba₂(Ca_{0.78}Mg_{0.20}Ce_{0.01}Na_{0.01})(BO₃)₂

Materials
BaCO₃: 4.539 g
CaCO₃: 0.898 g
MgO: 0.093 g
H₃BO₃: 1.564 g (Excess added for fluxing)
Na₂CO₃: 0.012 g (100% excess added)
CeO₂: 0.020 g

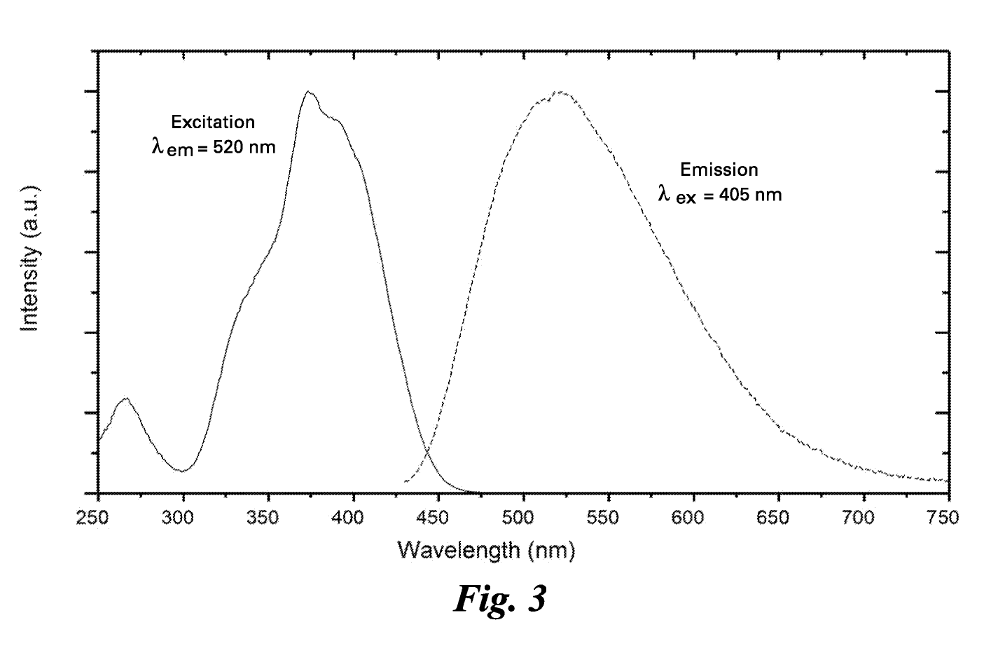

An emission spectrum of Ba₂(Ca_{0.78}Mg_{0.20}Ce_{0.01}Na_{0.01})(BO₃)₂ recorded with excitation at a wavelength of 405 nm is shown in FIG. 3.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A lighting apparatus capable of emitting white light, said lighting apparatus comprising
a semiconductor light source; and
a phosphor composition radiationally coupled to the light source, and comprising a phosphor of formula I
Ba₂₋ₐSrₐCa_{1-x-y-z}MgₓCe_{y}M¹_{b}M²_{z}(BO₃)₂ (I)
wherein
M¹ is Eu, Tb, Pr, Dy, Mn, or a combination thereof;
M² is Li, Na, K, Rb, or a combination thereof;
a≧0;
b≦0.1;
0.95>x>0;
0<y≦0.1; and
z≦0.1.

2. A lighting apparatus according to claim 1, wherein said phosphor is of formula
Ba₂₋ₐSrₐCa_{1-x-y-z}MgₓCe_{y}M²_{z}(BO₃)₂.

3. A lighting apparatus according to claim 1, wherein said phosphor is of formula
Ba₂Ca_{1-x-y-z}MgₓCe_{y}M¹_{b}M²_{z}(BO₃)₂.

4. A lighting apparatus according to claim 1, wherein said phosphor is of formula
Ba₂Ca_{1-x-y-z}MgₓCe_{y}M²_{z}(BO₃)₂.

5. A lighting apparatus according to claim 1, wherein x≧0.5.

6. A lighting apparatus according to claim 1, wherein 0.1≧x≧0.5.

7. A lighting apparatus according to claim 1, wherein the phosphor is of formula
Ba₂Ca_{0.78}Mg_{0.2}Ce_{0.01}Na_{0.01}(BO₃)₂.

8. A lighting apparatus according to claim 1, wherein the light source is a semiconductor light emitting diode emitting radiation having a wavelength in the range of from about 370 to about 470 nm.

9. A lighting apparatus according to claim 8, wherein the semiconductor light emitting diode comprises a nitride compound semiconductor represented by the formula InᵢGaⱼAlₖN,
wherein 0≦i;
0≦j,
0≦k, and
i+j+k=1.

10. A lighting apparatus according to claim 1, wherein said phosphor composition further comprises one or more phosphors in addition to the phosphor of formula I.

11. A phosphor of formula I
Ba₂₋ₐSrₐCa_{1-x-y-z}MgₓCe_{y}M¹_{b}M²_{z}(BO₃)₂ (I)
wherein
M¹ is Eu, Tb, Pr, Dy, Mn, or a combination thereof;
M² is Li, Na, K, Rb, or a combination thereof;
a≧0;
b≦0.1;
0.95>x>0;
0<y≦0.1; and
z≦0.1.

12. A phosphor according to claim 11, wherein said phosphor is of formula
Ba₂₋ₐSrₐCa_{1-x-y-z}MgₓCe_{y}²M²_{z}(BO₃)₂.

13. A phosphor according to claim 11, wherein said phosphor is of formula
Ba₂Ca_{1-x-y-z}MgₓCe_{y}M¹_{b}M²_{z}(BO₃)₂.

14. A phosphor according to claim 11, wherein said phosphor is of formula
Ba₂Ca_{1-x-y-z}MgₓCe_{y}M²_{z}(BO₃)₂.

15. A phosphor according to claim 11, wherein x≧0.5.

16. A phosphor according to claim 11, wherein 0.1≧x≧0.5.

17. A phosphor according to claim 11, wherein the phosphor is of formula
Ba₂Ca_{0.78}Mg_{0.2}Ce_{0.01}Na_{0.01}(BO₃)₂.

18. A phosphor blend comprising a phosphor of formula I
Ba₂₋ₐSrₐCa_{1-x-y-z}MgₓCe_{y}M¹_{b}M²_{z}(BO₃)₂ (I)
and at least one additional phosphor;
wherein
M¹ is Eu, Tb, Pr, Dy, Mn, or a combination thereof;
M² is Li, Na, K, Rb, or a combination thereof;
a≧0;
b≦0.1;
0.95>x>0;
0<y≦0.1; and
z≦0.1.

19. A phosphor blend according to claim 11, wherein said phosphor is of formula
Ba₂₋ₐSrₐCa_{1-x-y-z}MgₓCe_{y}M²_{z}(BO₃)₂.

20. A phosphor blend according to claim 11, wherein said phosphor is of formula
Ba₂Ca_{1-x-y-z}MgₓCe_{y}M¹_{b}M²_{z}(BO₃)₂.

21. A phosphor blend according to claim 11, wherein said phosphor is of formula
Ba₂Ca_{1-x-y-z}MgₓCe_{y}M²_{z}(BO₃)₂.

22. A phosphor blend according to claim 11, wherein x≧0.5.

23. A phosphor blend according to claim 11, wherein 0.1≧x≧0.5.

24. A phosphor blend according to claim 11, wherein the phosphor is of formula
Ba₂Ca_{0.78}Mg_{0.2}Ce_{0.01}Na_{0.01}(BO₃)₂.

25. A phosphor blend according to claim 11, capable of providing white light with a correlated color temperature (CCT) of 2500-10000K and a color rendering index (CRI) of 50-99.
